(19) United States
(12) Patent Application Publication
(10) Pub. No.: US 2025/0207698 A1
(43) Pub. Date: Jun. 26, 2025

(54) ADAPTER TO CONNECT METAL AND CERAMIC COMPONENTS

(71) Applicants: Saudi Arabian Oil Company, Dhahran (SA); CoorsTek Membrane Sciences AS, Oslo (NO)

(72) Inventors: Aadesh Harale, Dhahran (SA); Aqil Jamal, Dhahran (SA); Michael Ian Budd, Sandefjord (NO)

(21) Appl. No.: 18/392,709

(22) Filed: Dec. 21, 2023

(51) Int. Cl. F16L 25/00; B01D 53/22; B01D 71/02; C01B 3/50

(52) U.S. Cl. CPC F16L 25/0072; B01D 53/228; B01D 71/02231; C01B 3/505; B01D 2257/108

(57) ABSTRACT

The disclosure relates to adapters, systems, and methods to connect a metal component and a ceramic component. The systems and methods generally include a metal header, a header seal and a zirconia toughened alumina (ZTA) header.

### FIELD

The disclosure relates to adapters, systems, and methods to connect a metal component and a ceramic component. The systems and methods generally include a metal header, a header seal and a zirconia toughened alumina (ZTA) header.

### BACKGROUND

Stress generated by differences in thermal expansion behavior of connections between a metal component (e.g., a metal connector) and a ceramic component (e.g., a ceramic-supported membrane component) can lead to fracturing, cracking, and loss of hermeticity. A common material for the porous ceramic support is alumina. Ferritic steels, which generally have a lower coefficient of thermal expansion (CTE) than most other steels, still have a CTE that is much higher than that of alumina. Consequently, if a ferritic steel is bonded directly to alumina at a relatively high temperature, relatively high levels of stress can be generated in the joint on cooling from the sealing temperature and during any subsequent thermal cycling which may occur during operation. Alumina ceramics generally show poor tolerance to thermally generated strains, which can lead to joint failure.

### SUMMARY

The disclosure relates to adapters, systems, and methods to connect a metal component and a ceramic component. The systems and methods generally include a metal header, a header seal and a ZTA header.

The systems and methods allow for the formation of joints that are relatively mechanically robust, relatively hermetic, and/or relatively temperature resistant. Thus, the systems and methods can form relatively strong, relatively temperature-resistant, and/or relatively gas tight unions between a metal component and a ceramic component.

The systems and methods can reduce (e.g., prevent) fracturing, cracks, leaks/or and joint failure relative to certain other systems and methods for joining a ceramic component to a metal component. The systems and methods can be less prone to oxidation and leaking relative to certain other joining systems and methods, such as those based on graphite-based joining materials.

The systems and methods allow ceramic supported membranes, via the metal transition adaptor, to be integrated into membrane reactors (e.g., by welding). This in turn facilitates the construction of large membrane reactor systems containing multitudes of membranes which are suitable for gas separation on an industrial scale.

In a first aspect, the disclosure provides an adapter, including: a metal header including a bore, a header seal including a bore, and a zirconia toughened alumina (ZTA) header including a bore and a sealing stem. The header seal is disposed in the bore of the metal header, the sealing stem of the ZTA header is disposed in the bore of the metal header, and the header seal seals the metal header to the ZTA header.

In some embodiments, the sealing stem of the ZTA header includes a straight section starting at a first end of the ZTA header and a tapered section adjacent to the straight section; an exterior portion of the ZTA header adjacent to the tapered section of the sealing stem includes a shoulder; and the tapered section is configured such that an external diameter of the ZTA header increases from the first end to the shoulder.

In some embodiments, a taper angle of the tapered section of the ZTA header is from 10° to 45°.

In some embodiments, a maximum outer diameter of the tapered section of the ZTA header is at least 20% larger than an outer diameter of the straight section the ZTA header.

In some embodiments, the bore of the metal header includes: a straight section starting at a first end of the metal header, a sealing alignment cavity adjacent to the straight section, an internal shoulder adjacent to the sealing alignment cavity, and a mouth adjacent the internal shoulder starting at a second end of the metal header.

In some embodiments, the mouth of the bore of the metal header includes: a straight section adjacent to the internal shoulder, and a tapered section including a narrow end and a wide end starting at the second end of the metal header. The wide end of the tapered section of the mouth of the bore is at the second end of the metal header; and the narrow end of the tapered section of the mouth of the bore is adjacent to the straight section.

In some embodiments, a ratio of a radial thickness of the ZTA header to a radial thickness of the metal header increases moving towards the mouth of the metal header.

In some embodiments, a diameter of the sealing alignment cavity of the metal header is 0.1 mm to 5 mm wider than a diameter of the straight section of the ZTA header.

In some embodiments, the metal header includes ferritic steel and/or Inconel. In some embodiments, the header seal includes CaO·MgO·Al₂O₃·SiO₂, CaO·Al₂O₃·SiO₂, BaO·CaO·Al₂O₃·SiO₂, CaO·ZnO·SiO₂, BaO·Al₂O₃·SiO₂·B₂O₃, BaO·Y₂O₃·SiO₂·B₂O₃, and/or CaO·La₂O_{3·}SiO₂ B₂O₃·

In some embodiments, the header seal bas a CTE of 8.0×10⁻⁶ K⁻¹ to 10×10⁻⁶ K⁻¹

In some embodiments, a CTE of the header seal is no more than 2×10⁻⁶ K⁻¹ lower than and no more than 1×10⁻⁶ K⁻¹ higher than a CTE of the ZTA header over a temperature range of 25-800° C.

In some embodiments, the ZTA header has a zirconia content of at least 20 wt. %.

In some embodiments, the ZTA header has a coefficient of thermal expansion (CTE) of 8.5×10⁻⁶ K⁻¹ to 9.3×10⁻⁶ K⁻¹ over the temperature range 25-1000° C.

In some embodiments, the adapter further includes a multi-socket ZTA manifold base attached to the ZTA header opposite the metal header.

In some embodiments, the adapter further includes a flow separator plate attached to the ZTA header opposite the metal header; and a base plate attached to the flow separator plate opposite the ZTA header. The flow separator plate includes a plurality of holes. A face of the base plate adjacent to the flow separator plate includes a plurality of holes and a plurality of diagonal channels. The holes of the base plate are in fluid communication with a first portion of the holes of the flow separator plate. The channels of the base plate are in fluid communication with a second portion of the holes of the flow separator plate different from the first portion.

In a second aspect, the disclosure provides a system including: a metal component, a ceramic component, and an adapter of the disclosure. The adapter joins the metal component and the ceramic component.

In a third aspect, the disclosure provides a system including a hydrogen separation membrane reactor including a ceramic-supported membrane including a porous ceramic support and a membrane selected from the group consisting of palladium and a palladium alloy; a metal reactor component; and an adapter of the disclosure. The porous ceramic support is sealed to the ZTA header of the adapter. The metal reactor component is sealed to the metal header of the adapter.

In a fourth aspect, the disclosure provides a method of forming an adapter, including: inserting a header seal preform and a portion of a ZTA header into a bore of a metal header; and heating the metal header, header seal preform, and ZTA header to form the adapter.

In certain embodiments, the heating causes the header seal preform to flow and contact a surface of the ZTA header and a surface of the metal header and at least partially crystallize.

### BRIEF DESCRIPTION OF THE FIGURES

FIG. 1A schematically depicts a cross section of an adapter prior to sealing.

FIG. 1B schematically depicts a cross section of an adapter after sealing.

FIG. 2 schematically depicts a cross section of a ZTA header.

FIG. 3 schematically depicts a cross section of a metal header.

FIG. 4 schematically depicts a cross section of a header seal preform.

FIG. 5A schematically depicts an adapter.

FIG. 5B schematically depicts a cross section of the adapter of FIG. 5A.

FIG. 6A schematically depicts a cross section of an adapter after sealing.

FIG. 6B schematically depicts an adapter prior to sealing.

FIG. 7A schematically depicts a cross section of a metal header.

FIG. 7B schematically depicts a cross section of a ZTA header.

FIG. 7C schematically depicts a cross section of a header seal.

### DETAILED DESCRIPTION

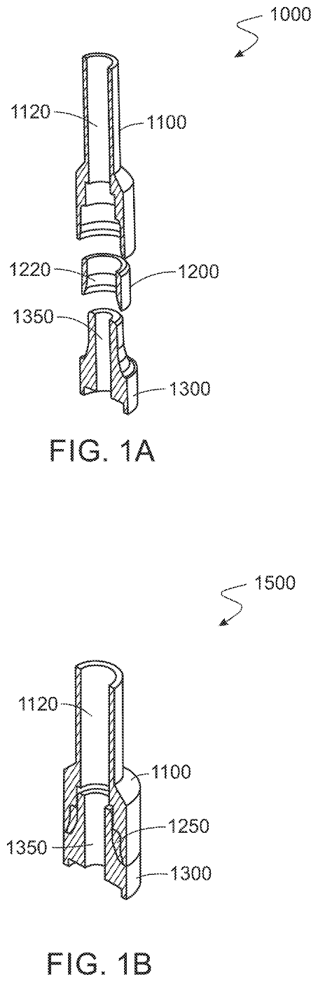

FIGS. 1A and 1B show cross sections of an adapter prior to sealing 1000 and after sealing 1500, respectively. The adapter prior to sealing 1000 and after sealing 1500 includes a metal header 1100, and a ZTA header 1300. The adapter prior to sealing 1000 includes a header seal preform 1200 and the adapter after sealing 1500 includes a header seal 1250. During the sealing operation, the header seal preform 1200 becomes the header seal 1250 (see discussion below). The metal header 1100, header seal preform 1200, and ZTA header 1300 each include a respective bore 1120, 1220, 1350. The adapter 1500 can be used to join a ceramic component and a metal component to provide a connection between the components. In general, the connections formed by the adapter 1500 between the ceramic component and the metal component are relatively mechanically robust, relatively gas-tight and/or relatively temperature resistant. Without wishing to be bound by theory, it is believed that the adapter 1500 can tolerate relatively high stresses without mechanical failure.

When the adapter 1500 is sealed, as shown in FIG. 1B, the header seal 1250 is disposed in the bore 1120 of metal header 1100 and a portion of the ZTA header 1300 is disposed in the bore 1120 of the metal header 1100. The ZTA header 1300 is sealed inside the metal header 1100 using the header seal 1250.

Without wishing to be bound by theory, it is believed that the robustness of the adapter 1500 depends on the geometry of its component parts (the metal header 1100, the header seal 1250, and the ZTA header 1300).

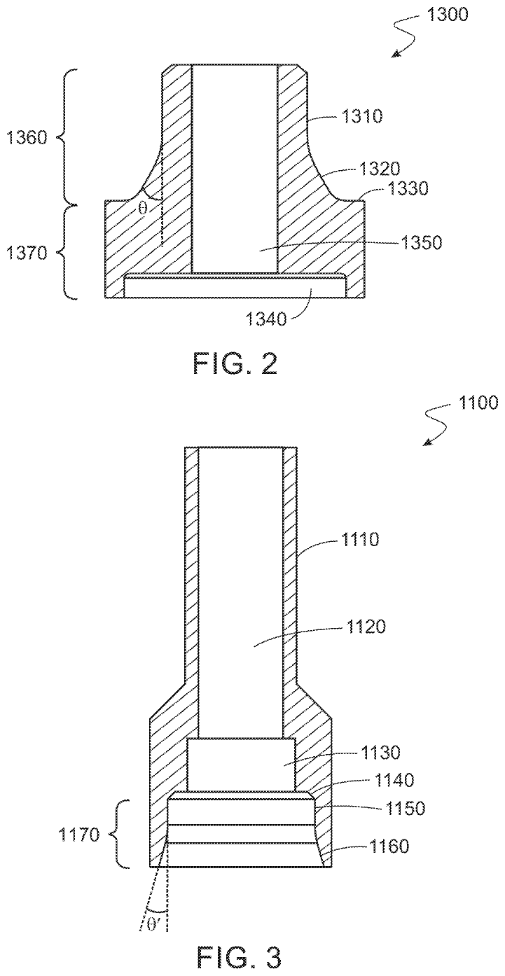

FIG. 2 depicts a cross section of the ZTA header 1300. The ZTA header 1300 includes a sealing stem 1360, a socket 1340, the bore 1350, and a main body 1370. The sealing stem 1360 includes a straight section 1310 and a tapered section 1320. A shoulder 1330 is formed where the sealing stem 1360 meets the main body 1370.

When the adapter 1500 is sealed, the metal header 1100 encloses the sealing stem 1360 of the ZTA header 1300, but the main body 1370 of the ZTA header 1300 protrudes beyond the end of the metal header 1100 so that the ceramic component (e.g., a porous alumina support) may conveniently be positioned within the socket 1340 when sealing the ceramic component to the adapter 1500.

Without wishing to be bound by theory, it is believed that the tapered section 1320 between the straight section 1310 and the shoulder 1330 of the ZTA header 1300 provides mechanical strength to the adapter 1500. In some embodiments, the taper angle, shown in FIG. 2 as 0, is at least 10° (e.g., at least 15°, at least 20°, at least 25°, at least 30°, at least 35°, at least) 40° and/or at most 45° (e.g., at most 40°, at most 35°, at most 30°, at most 25°, at most 20°, at most) 15°. Without wishing to be bound by theory, it is believed that such angles provide good performance. Taper angles greater than 45° can produce relatively large shear stresses at joint interfaces. Taper angles less than 10° may involve an extended axial length to accommodate the increase in sealing stem 1360 diameter.

Typically, the maximum outer diameter of the tapered section 1320 is at least 20% larger than an outer diameter of the straight section 1310 at the location where the tapered section 1320 meets the shoulder 1330. This can be achieved by selecting an appropriate length and/or taper angle for the tapered section 1320. Without wishing to be bound by theory, it is believed that excessive increases in the diameter (e.g., the maximum outer diameter of the tapered section 1320 is greater than 50% larger than the outer diameter of the straight section 1310 at the location where it meets the shoulder 1330) can increase costs and bulkiness. In general, it is desirable to have a relatively gentle transition between the straight section 1310 and the tapered section 1320 to avoid excessive local stresses, which can initiate a fracture. In some embodiments, the fillet radius for the transition from the parallel section 1310 to the tapered section 1320 is at least 1 (e.g., at least 2, at least 3) mm.

In general, the bore 1350 of the ZTA header 1300 is kept sufficiently small to avoid reductions in strength of the adapter 1500, but large enough to be compatible with desired gas flow during use. The diameter of the bore 1350 of the ZTA header 1300 can be increased at one or both ends to improve local gas flow, such as by including a chamfer or fillet. Without wishing to be bound by theory, it is believed that such a modification would not negatively impact the integrity of the adaptor since these are not in relatively high stress locations.

In general, the ZTA header 1300 includes zirconia. In some embodiments, the ZTA header 1300 has a zirconia (in the form of partially stabilized zirconia, such as 3Y-PSZ) content of at least 20 (e.g., at least 25, at least 30, at least 35, at least 40, at least 45, at least 50, at least 55, at least 60, at least 65, at least 70, at least 75) wt. % and/or at most 80 (e.g., at most 75, at most 70, at most 65, at most 60, at most 55, at most 50, at most 45, at most 40, at most 35, at most 30, at most 25) wt. %. Without wishing to be bound by theory, it is believed that the zirconia content of the ZTA header 1300 influences the CTE of the ZTA header 1300 and provides strength and fracture toughness. In some embodiments, the ZTA header 1300 has a CTE of at least 8.5×10⁻⁶ (at least 8.6×10⁻⁶, at least 8.7×10⁻⁶, at least 8.8×10⁻⁶, at least 8.9×10⁻⁶, at least 9.0×10⁻⁶, at least 9.1×10⁻⁶, at least 9.2×10⁻⁶) K⁻¹ over the range 25-1000° C. and/or at most 9.3×10⁻⁶ (e.g., at most 9.2×10⁻⁶, at most 9.1×10⁻⁶, at most 9.0×10⁻⁶, at most 8.9×10⁻⁶, at most 8.8×10⁻⁶, at most 8.7×10⁻⁶, at most 8.6×10⁻⁶) K⁻¹ over the range 25-1000° C. In some embodiments, the ZTA header 1300 has a strength of at least 500 MPa. In some embodiments, the ZTA header 1300 has a fracture toughness (K_{1C}) of at least 5 MPa·m^{1/2}.

Relatively small amounts of a secondary oxide can be added to the zirconia to impart a suitable degree of stabilization. Without wishing to be bound by theory, it is believed that the secondary oxide is in solution in the zirconia phase. Examples of the secondary oxide include MgO, Y₂O₃, CeO₂ and CaO. Typical levels of stabilizers in the zirconia phase are 2-5 mol. % (corresponding to approximately 1.5-10 wt. % depending on the oxide).

FIG. 3 depicts a cross section of the metal header 1100. The metal header 1100 includes a stem 1110, the bore 1120, a sealing alignment cavity 1130, an internal shoulder 1140 and a mouth 1170 divided into a straight section 1150 and tapered section 1160. In general, the angle θ′ of the tapered section 1160 should not be greater than the taper angle 0 of the sealing stem 1360 of the ZTA header 1300. In some embodiments, the tapered section 1160 is not included.

In general, the metal header 1100 can include any metal with a relatively low thermal expansion coefficient such as ferritic steels or Inconel. Generally, the CTE of the metal header 1100 can be 10×10⁻⁶ K⁻¹ to 17×10⁻⁶ K⁻¹ over the range 25-800° C. The metal header 1100 should have sufficient refractoriness to withstand the sealing process which would typically be carried out at 800-1000° C. (see discussion below) and should be chemically compatible with process gases in service.

Without wishing to be bound by theory, it is believed that the geometry of the metal header 1100 has a strong influence on the mechanical robustness and gas-tightness of the adapter 1500. In general, the diameter of the stem 1110 and the bore 1120 are chosen to match the size of the metal component to which the metal header 1100 will be joined. Generally, it is desirable for the diameter of the sealing alignment cavity 1130 to be slightly larger (0.1-0.5 mm) than the diameter of the straight section 1310 of the ZTA header 1300, and sufficiently deep such that the sealing stem 1360 does not abut the end of the sealing alignment cavity 1130 during the sealing process so that the sealing alignment cavity 1130 can accommodate the straight section 1310 of the sealing stem 1360 of the ZTA header 1300 when the assembly is sealed. Without wishing to be bound by theory, it is believed that if the sealing stem 1360 of the ZTA header 1300 were to contact the end of the sealing alignment cavity 1130 it would prevent the continued travel of the metal header 1100 and the complete pressing of the header seal preform 1200 into place. The end of travel is defined as the point at which the rim of the mouth of the metal header 1100 makes contact with the shoulder 1330 of the ZTA header 1300.

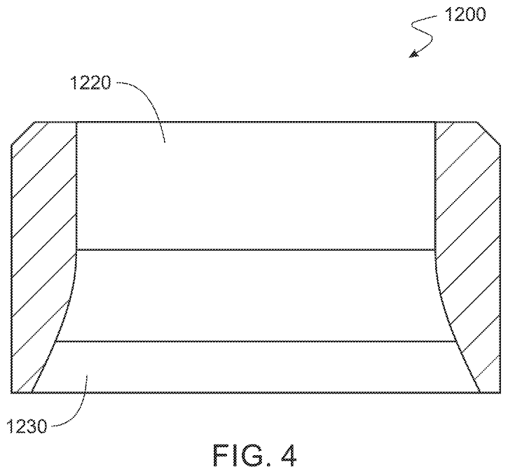

FIG. 4 depicts a cross section of the header seal preform 1200. To form the adapter 1500, a high temperature sealing operation is employed. In the high temperature sealing operation the metal header 1100, the header seal preform 1200 and the ZTA header 1300 are assembled by inserting the header seal preform 1200 and sealing stem 1360 of the ZTA header 1300 into the mouth 1170 of the metal header 1100 and heated to a temperature which is sufficiently high to allow the header seal preform 1200, which is in a glassy state, to flow and contact the joint surfaces of the ZTA header 1300 and metal header 1100 and then to at least partially crystallize to form the header seal 1250, which includes (e.g., consists of) a glass-ceramic. In certain embodiments, the sealing temperature is at least 800 (e.g., at least 850, at least 900, at least 950)° C. and/or at most 1000 (e.g., at most 950, at most 900, at most 850)° C. The sealing process can include a dwell at the sealing temperature to ensure the desired degree of crystallization of the header seal 1250 is obtained to provide the correct CTE. The sealed assembly is cooled at a controlled rate after sealing to avoid large thermal gradients that may cause fractures. Without wishing to be bound by theory, it is believed that it is beneficial to apply an axial load during the sealing process to assist in pressing the header seal into place as it softens and flows. It is also believed that it is beneficial to use jigs to ensure that alignment of the parts is maintained during the sealing process.

The primary function of the sealing alignment cavity 1130 of the metal header 1100 is to help maintain the axial alignment of the component parts of the adapter 1500 during the sealing process. A small axial load, typically 1-100 N, is typically applied during the sealing operation. The internal shoulder 1140 of the metal header 1100 is used to transfer this load to the header seal preform 1200 to cause the header seal preform 1200 to flow into place during the high temperature sealing operation. The mouth 1170 of the metal header 1100 is sufficiently wide to accommodate the header seal preform 1200. Without wishing to be bound by theory, it is believed that it is beneficial to include the tapered section 1160 at the opening of the mouth 1170 to aid the flow of sealing material during the sealing operation and to improve the contact between the header seal 1250, the metal header 1100 and the ZTA header 1300. Including the tapered section 1160 can also lead to a reduction in the level of stress in the adapter 1500 in the vicinity of the opening of the metal header 1100.

In general, the header seal 1250 is a glass-ceramic with a CTE closely matching that of the ZTA header 1300, formed by the crystallization of the vitreous header seal preform 1200. Examples of the materials which might be used for header seal preform 1200 include glasses from the CaO·MgO·Al₂O₃·SiO₂, CaO·Al₂O₃·SiO₂, BaO·CaO·Al₂O₃·SiO₂, CaO·ZnO·SiO₂, BaO·Al₂O₃·SiO₂·B₂O₃, BaO·Y₂O₃·SiO₂·B₂O₃, and CaO·La₂O₃·SiO₂·B₂O₃ systems. In certain embodiments, the header seal 1250 has a CTE of at least 8.0×10⁻⁶ (e.g., at least 8.1×10⁻⁶, at least 8.2×10⁻⁶, at least 8.3×10⁻⁶, at least 8.4×10⁻⁶, at least 8.5×10⁻⁶, at least 8.6×10⁻⁶, at least 8.7×10⁻⁶, at least 8.8×10⁻⁶, at least 8.9×10⁻⁶, at least 9.0×10⁻⁶, at least 9.1×10⁻⁶, at least 9.2×10⁻⁶, at least 9.3×10⁻⁶, at least 9.4×10⁻⁶, at least 9.5×10⁻⁶, at least 9.6×10⁻⁶, at least 9.7×10⁻⁶, at least 9.8×10⁻⁶, at least 9.9×10⁻⁶) K⁻¹ and/or at most 10×10⁻⁶ (e.g., at most 9.9×10⁻⁶, at most 9.8×10⁻⁶, at most 9.7×10⁻⁶, at most 9.6×10⁻⁶, at most 9.5×10⁻⁶, at most 9.4×10⁻⁶, at most 9.3×10⁻⁶, at most 9.2×10⁻⁶, at most 9.1×10⁻⁶, at most 9.0×10⁻⁶, at most 8.9×10⁻⁶, at most 8.8×10⁻⁶, at most 8.7×10⁻⁶, at most 8.6×10⁻⁶, at most 8.5×10⁻⁶, at most 8.4×10⁻⁶, at most 8.3×10⁻⁶, at most 8.2×10⁻⁶, at most 8.1×10⁻⁶) K⁻¹ over the temperature range 25-800° C. In certain embodiments, the CTE of the header seal 1250 is less than 1×10⁻⁶ K⁻¹ higher than and/or no more than 2×10⁻⁶ K⁻¹ lower than the CTE of the ZTA header 1300 over the temperature range 25-800° C. In certain embodiments, the header seal 1250 has a dilatometric softening point according to ASTM E228 of at least 700 (e.g., at least 800, at least 900)° C. Without wishing to be bound by theory, it is believed that it can be desirable to use glass-ceramic for the header seal 1250 rather glass because glass-ceramic can exhibit better mechanical and chemical stability than glass at relatively high temperatures (e.g., at least 450° C.).

The header seal preform 1200 can be either pressed and sintered, or machined from solid material. In general, it is desirable for the bore 1220 of the header seal preform 1200 to fit snuggly on the straight section 1310 of the sealing stem 1360 of the ZTA header 1300, and the outer diameter of the header seal preform 1200 can be slightly (0.1-0.2 mm) smaller than the diameter of the straight section 1150 of the mouth 1170 of the metal header 1100. The height of the header seal preform 1200 can be chosen such that the sealing stem 1360 of the ZTA header 1300 protrudes enough beyond the end of the header seal 1250 preform to be engaged in the sealing alignment cavity 1130 of the metal header 1100 when the components are assembled in preparation for sealing. In some embodiments, an inner surface of the header seal preform 1200 includes a taper 1230. The taper 1230 on the inner surface of the header seal preform ideally matches the taper of the sealing stem 1360 of the ZTA header 1300. The inclusion of a taper 1230 allows the header seal preform 1200 to be positioned closer to the shoulder 1330 of the ZTA header 1300.

When the metal header 1100 is sealed to the ZTA header 1300, the header seal 1250 should ideally almost completely (>95%) fill the seal cavity between the metal header 1100 and the ZTA header 1300 without overfilling it. The seal cavity is the empty space between the internal surface of the metal header 1100 and the external surface of the ZTA header 1300 when the opening at the mouth of the metal header 1100 is in contact with the shoulder 1330 of the ZTA header 1300. This corresponds to the space occupied by the header seal 1250 in FIG. 1B. The volume of the header seal preform 1200 is chosen accordingly (e.g., by adjusting the height) taking into account, if appropriate, any volumetric changes which occur in the material of the header seal preform 1200 when it crystallizes during the sealing process. In general, the material of the header seal 1250 preform has a relatively high relative density to minimize any sintering shrinkage that may occur during sealing which would reduce the degree of filling of the seal cavity. Application of the sealing material in the form of paste or green, tape-cast preform is therefore not suitable. The rim of the mouth 1170 of the metal header 1100 comes to rest against the shoulder 1330 of the ZTA header 1300 as the header seal 1250 preform deforms during the sealing operation to give a well-defined seal cavity which is almost completely filled with glass-ceramic of the header seal 1250.

The taper on the sealing stem 1360 of the ZTA header 1300 produces a joint where the ratio of the radial thickness of the ZTA header 1300 to the radial thickness of the metal header 1100 increases towards the mouth 1170 of the metal header 1100, thereby decreasing the level of stress in the ZTA header 1300 in this region. At the same time, the straight section 1310 of the sealing stem 1360 on the ZTA header 1300 ensures hermeticity because the sealing interfaces between the metal header 1100 and the glass-ceramic of the header seal 1250 and the ZTA header 1300 and the glass-ceramic of the header seal 1250 in this region are in radial compression with low or zero levels of shear stress.

In general, the dimensions of the metal header 1100, the header seal preform 1200 and the ZTA header 1300 can be selected as appropriate based on the intended application. Additionally, the assembly and installation of the adapter 1500 would be dependent on the intended application.

In general, the metal header 1100 can be joined to the metal component by any suitable method, such as by welding. Examples of the metal component to which the metal header 1100 is to be joined include metal flanges, manifolds, and process gas connections.

Generally, the ZTA header 1300 can be joined to any ceramic component that has a CTE similar to that of the ZTA header 1300. In general, the ZTA header 1300 can be joined to the ceramic component by any suitable method, such as in a high temperature sealing operation with a glass-ceramic sealing material which has a thermal expansion coefficient close to that of the ceramic component. In certain embodiments, the high temperature sealing operation is performed at a temperature of at least 800 (e.g., at least 850, at least 900, at least 950)° C. and/or at most 1000 (e.g., at most 950, at most 900, at most 850)° C. In certain embodiments, the glass-ceramic sealing material has a dilatometric softening point of at least 700 (e.g., at least 800, at least 900)° C. In certain embodiments, the glass-ceramic sealing material has a CTE of at least 7.0×10⁻⁶ (e.g., at least 7.1×10⁻⁶, at least 7.2×10⁻⁶, at least 7.3×10⁻⁶, at least 7.4×10⁻⁶, at least 7.5×10⁻⁶, at least 7.6×10⁻⁶, at least 7.7×10⁻⁶, at least 7.8×10⁻⁶, at least 7.9×10⁻⁶, at least 8.0×10⁻⁶, at least 8.1×10⁻⁶, at least 8.2×10⁻⁶, at least 8.3×10⁻⁶, at least 8.4×10⁻⁶, at least 8.5×10⁻⁶, at least 8.6×10⁻⁶, at least 8.7×10⁻⁶, at least 8.8×10⁻⁶, at least 8.9×10⁻⁶) K⁻¹ and/or at most 9×10⁻⁶ (e.g., at most 8.9×10⁻⁶, at most 8.8×10⁻⁶, at most 8.7×10⁻⁶, at most 8.6×10⁻⁶, at most 8.5×10⁻⁶, at most 8.4×10⁻⁶, at most 8.3×10⁻⁶, at most 8.2×10⁻⁶, at most 8.1×10⁻⁶, at most 8.0×10⁻⁶, at most at most 7.9×10⁻⁶, at most 7.8×10⁻⁶, at most 7.7×10⁻⁶, at most 7.6×10⁻⁶, at most 7.5×10⁻⁶, at most 7.4×10⁻⁶, at most 7.3×10⁻⁶, at most 7.2×10⁻⁶, at most 7.1×10⁻⁶) K⁻¹ over the temperature range 25-800° C. Without wishing to be bound by theory, it is believed that a glass-ceramic is preferred over glass as it has improved mechanical and chemical stability relative to glass at temperatures which might typically be encountered during service (e.g., 450-800° C.). Examples of the glass-ceramic sealing material include materials from CaO·MgO·Al₂O₃·SiO₂, CaO·Al₂O₃·SiO₂, BaO·CaO·Al₂O₃·SiO₂, CaO·ZnO·SiO₂, BaO·Al₂O₃·SiO₂·B₂O₃, BaO·Y₂O₃·SiO₂·B₂O₃, and CaO·La₂O₃·SiO₂·B₂O₃ systems.

The adapter 1500 can be used in a hydrogen separation membrane reactor that includes a porous ceramic support such as a ceramic-supported, palladium or palladium alloy membrane. For example, the porous ceramic support would be sealed into the socket 1340 of the ZTA header 1300 using a glass-ceramic sealing material in a second sealing operation after the adaptor 1500 had been fabricated. The palladium or palladium alloy membrane would be applied to the porous ceramic support in a subsequent operation. The resulting assembly of ceramic supported palladium or palladium alloy membrane sealed to the adapter 1500 could then be joined to other reactor components such as process gas pipework or gas distribution manifolds, for instance, by welding. Such membranes can be used in hydrogen production, ammonia cracking and/or syngas production (e.g., from carbon dioxide).

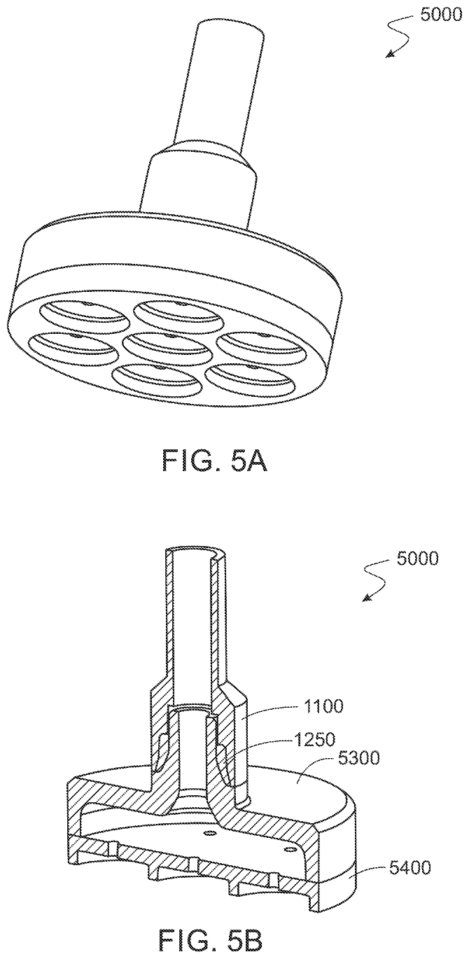

FIG. 5A depicts a schematic of an adapter 5000 and FIG. 5B depicts a cutaway view of the adapter 5000. The adapter 5000 includes the metal header 1100, the header seal 1250, a ZTA manifold header 5300 and a multi-socket ZTA manifold base 5400. In the adapter 5000, the ZTA manifold header 5300 functions as a manifold lid, which is sealed to the multi-socket ZTA manifold base 5400 with a suitable glass-ceramic sealing material such as the one used for the header seal 1250. The multi-socket ZTA manifold base 5400 can include ZTA or alumina.

The adapter 5000 can function as a manifold. As an inlet manifold, it would serve to distribute gas from a single inlet (entering through the metal header 1100) into seven ceramic-supported palladium or palladium alloy membrane tubes. As an outlet manifold, it would collect gas from seven ceramic-supported palladium or palladium alloy membrane tubes into a single outlet (exiting through the metal header 1100).

The multi-socket ZTA manifold base 5400 is configured to accept seven tubular ceramic components. The multi-socket ZTA manifold base 5400 can be designed to accept any desired number of ceramic components, such as two, three, four, five, six, eight, nine, ten, or more ceramic components.

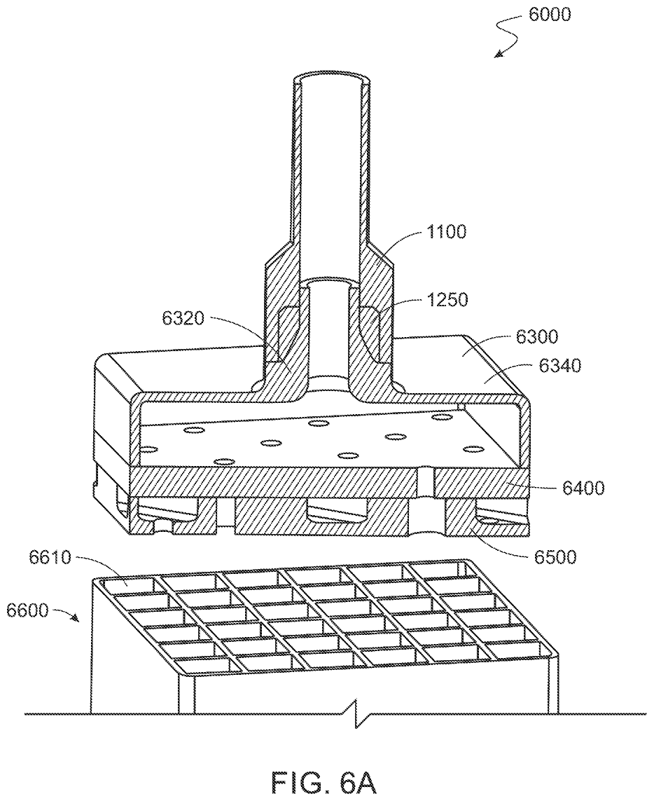

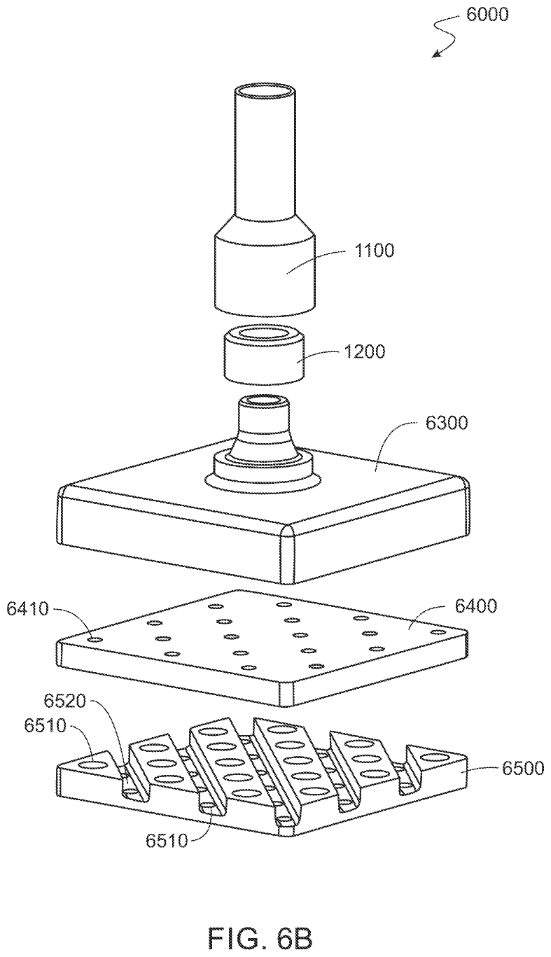

FIG. 6A depicts a cutaway view of an adapter 6000 and FIG. 6B depicts the adapter 6000 prior to sealing. The adapter 6000 includes the metal header 1100, the header seal 1250, a ZTA header 6300 including a stem 6320 and body 6340, a flow separator plate 6400, and a base plate 6500. Prior to sealing, the adapter 6000 includes the header seal preform 1200 rather than the header seal 1250.

The ZTA header 6300 includes (e.g., consists of) ZTA. The flow separator plate 6400 and the base plate 6500 include (e.g., consist of) a ceramic such as ZTA (but possibly with a lower zirconia content than the ZTA of the ZTA header 6300) or alumina. Generally, the CTE of the ZTA header 6300, the flow separator plate 6400, and the base plate 6500 should be similar (e.g., less than 1-2×10⁻⁶ K⁻¹ difference over the range 25-1000° C.).

Referring to FIG. 6A, the adapter 6000 can be sealed to a multi-channel monolith 6600, such as a multi-channel, porous alumina honeycomb support. The multi-channel monolith 6600 includes (e.g., consist of) a ceramic. In some embodiments, the multi-channel monolith 6600 is a multi-channel monolithic membrane support. In some embodiments, the multi-channel monolith 6600 is porous. Without wishing to be bound by theory, it is believed that the ZTA header 6300 forms and acts as a manifold lid.

The base plate 6500 has an array of holes 6510 which perforate the base plate 6500. The holes 6510 are spaced to match the arrangement of channels 6610 in the multi-channel monolith 6600, generally with one hole 6510 for each channel 6610. The lower surface of the base plate 6500 is configured to allow sealing to the end of the multi-channel monolith 6600 (e.g., the lower surface of the base plate 6500 is flat). The upper surface of the base plate 6500 contains a series of diagonal grooves 6520 aligned to intersect alternate, diagonal rows of the holes 6510.

The flow separator plate 6400 has through-holes 6410 which correspond to the position of each of the holes 6510 which are not intersected by the diagonal grooves 6520. Without wishing to be bound by theory, it is believed that when the base plate 6500 and the flow separator plate 6400 are sealed together, they allow gas from alternate channels 6610 to pass straight through and force the gas from the adjacent channels 6610 out of the side of the manifold, through the diagonal grooves 6520. This arrangement therefore allows for distribution/collection of gas flows through the multi-channel monolith 6600 in a checkerboard pattern.

The ceramic components of the adapter 6000 (e.g., the ZTA header 6300, the flow separator plate 6400 and the base plate 6500) can be sealed together using a glass-ceramic sealing material of suitable CTE (e.g., no more than 1×10⁻⁶ K⁻¹ higher than, and no more than 2×10⁻⁶ K⁻¹ less than the CTE of the ceramic components over the temperature range 25-800° C.). Sealing of the ceramic components of the adapter 6000 can be completed before the metal header 1100 is sealed to the stem of the ZTA header 6300 to form the adapter 6000. The multi-channel monolith 6600 can be sealed to the lower face of the base plate 6500 in a subsequent operation.

### EXAMPLES

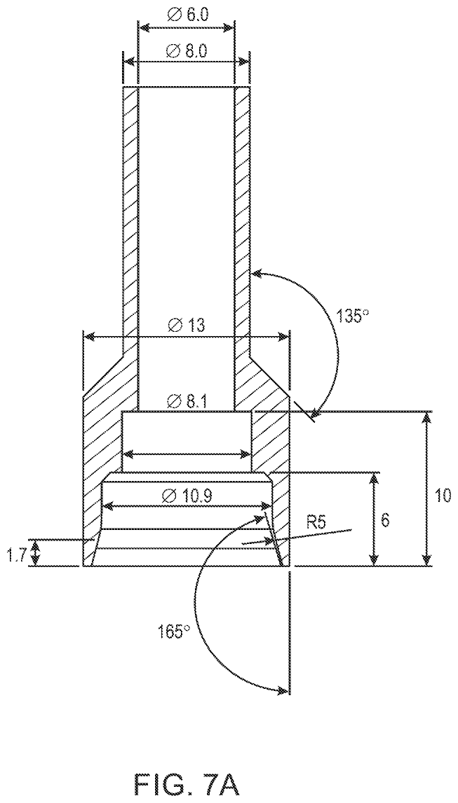

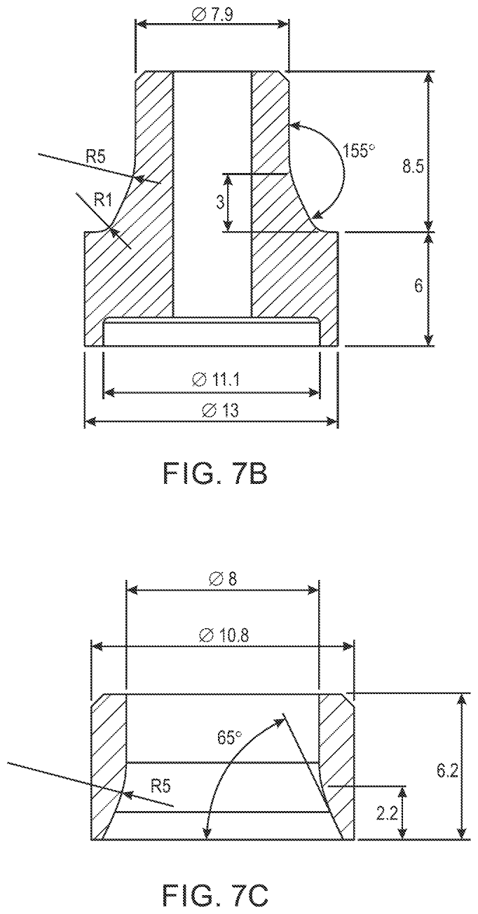

Metal headers were machined from heat resistant ferritic steel (Grade 1.4762) with the dimensions shown in FIG. 7A. The steel headers were washed, dried and pre-oxidized in air at 950° C. for 1 hour in preparation for sealing with heating and cooling rates of 5 K/min.

ZTA with a partially stabilized (3Y-PSZ) zirconia content of 40 wt. % was used for ZTA headers. The ZTA obtained was procured from Almath Crucibles, Newmarket, UK in the form of thick-walled cylinders which were subsequently machined with diamond tooling to the dimensions provided in FIG. 7B by LouwersHanique BV, Hapert, NL. R1 and R5 refer to the radius of curvature (1 mm and 5 mm, respectively) of the transitions between the tapered part and the straight or perpendicular features of the ZTA headers.

The CTE of this ZTA material was measured to be 9.1×10⁻⁶ K⁻¹ (25-1000° C.). The CTE was measured using a Model 801L dilatometer (Bähr Thermoanalyse, Hüllhorst, DE) equipped with an alumina pushrod and sample holder. The measurement was performed in air at a heating rate of 3K/min on a 4 mm×4 mm×50 mm sample. Correction factors obtained on a calibrated sapphire material measured under similar conditions were applied to correct for pushrod/holder expansion effects.

The header seal preforms were produced from a sintered CaO·MgO·Al₂O₃·SiO₂ based glass powder, which crystallizes during sealing at 950° C. to form a glass-ceramic with a CTE of 9.0×10⁻⁶ K⁻¹ (25-1000° C.). The CTE was measured as described above. Cylindrical pellets were pressed and sintered in house and preforms were machined from these pellets by LouwersHanique BV, Hapert, NL to the dimensions provided in FIG. 7C.

A number of adapters, each including a ZTA header, a header seal preform, and a pre-oxidized steel header were assembled by stacking the components. The adapters were placed in a square-ended, fused silica tube with an internal diameter of 18 mm together with heat-resistant steel alignment and loading fixtures and subsequently transferred to a vertical tube furnace for sealing. Sealing was accomplished by heating the assembled components in air at 5 K/min to a holding temperature of 950° C., holding at this temperature for 1 hour and then cooling to room temperature at 5 K/min or slower. An axial compressive load of approximately 0.8 N was applied to each assembly throughout the entire sealing cycle.

The sealed adapters were subsequently put through a second sealing cycle to seal a short, 10 mm diameter, closed ended, dense alumina tube into the socket on the ZTA header of each adapter. For each adapter, an annular seal preform that was approximately 1.2 mm thick×11 mm OD×7.5 mm ID, was placed in the socket and the open end of the short alumina tube was then inserted. The assembled parts were stacked in square-ended fused quartz tubes together with heat-resistant steel alignment and loading fixtures and subjected to a thermal treatment in air at 950° C. for 1 hour with an applied axial load of approximately 0.8 N. The seal preform was a sintered CaO·MgO·Al₂O₃·SiO₂ based glass powder which converts to a glass-ceramic with a CTE of 7.9×10⁻⁶ K⁻¹ (25-1000° C.) during the sealing cycle. The closed-ended alumina tubes were sealed to the adapters to allow them to be pressure and leak tested. Without wishing to be bound by theory, it is believed that subjecting the sealed adapters to a second sealing cycle at 950° C. to seal the dense alumina tube section prior to pressure and leak testing was important as this replicates the process which would be used to join the adapter to a porous alumina support prior to application of the palladium membrane.

The adapters sealed to alumina tubes were subjected to leak testing at 600° C. and room temperature. Prior to leak testing, a 250 mm long, 8 mm OD×6 mm ID steel extension tube (Grade 314) was welded to the stem of the steel headers of each assembly to allow the adapters to be positioned in a heated reactor tube. The test samples were mounted in the reactor using Swagelok® fittings at the cold ends of the reactor tube. The reactor tube was placed in a split vertical tube furnace. Leak tests were performed with an applied external pressure of 21.5 bara N₂ throughout 5 thermal cycles between 200° C. and 600° C. with heating and cooling rates of 5 K/min. Helium (1.45 mL/min at 1.5 bara) was used as a sweep gas on the inside of the adapters. The N₂ content of the sweep gas was measured by on-line GC analysis to enable the N₂ leak rate from the outside to the inside of the ZTA-metal transition adaptors under the large pressure gradient to be calculated (the detection limit for N₂ was approximately 20 ppm). No leaks were detected at any stage of testing in three of the four test samples. The fourth sample exhibited a leak rate of approximately 0.045 mbar L s⁻¹ which did not vary throughout the 5 thermal cycles. The observation that the leakage rate was independent of temperature cycling suggested that it was not in an area where there were significant differences between the CTEs of the component parts and hence not in the adapter. The leakage site was subsequently found to be located at the closed end of the alumina tube in a bubble test where the test sample was subjected to an internal over-pressure of 3 bar whilst immersed in isopropanol. These leak tests show that the adapters are essentially gas-tight at temperatures up to at least 600° C.

A further 5 samples were pressure tested up to 40 bar internal over-pressure at 600° C. by pressurizing with argon. All samples were intact on completion of the high temperature pressure tests, demonstrating the high temperature robustness of the adapters. These five samples and an additional two samples were hydrostatically tested at room temperature at internal pressures of up to 300 bar using deionized water as the pressurizing medium. A manual, 2-stage hand pump rated at 700 bar (model PDSA40H2O, FPT S.r.l., Italy) was used to pressurize the test samples which were attached via Swagelok® connectors. The pressure was recorded using a LEO Record pressure data logger—300 bar capacity, Keller AG, Switzerland. Failure occurred in the seal between the ZTA header and the closed-ended alumina tube in two samples (at 52 and 97 bar), and in the dense alumina tube in a further two samples (at 157 and 211 bar). The remaining three samples remained intact after pressurizing to more than 300 bar. No failure was observed in the adapter in these hydrostatic pressure tests, indicating that they are mechanically very robust.

The results demonstrate that the adapter functions well under separation and reactive separation conditions.

### Embodiments

1. An adapter, including:
a metal header including a bore;
a header seal including a bore; and
a zirconia toughened alumina (ZTA) header including a bore and a sealing stem,
wherein:
   the header seal is disposed in the bore of the metal header;
   the sealing stem of the ZTA header is disposed in the bore of the metal header; and
   the header seal seals the metal header to the ZTA header.

2. The adapter of embodiment 1, wherein:
the sealing stem of the ZTA header includes:
   a straight section starting at a first end of the ZTA header; and
   a tapered section adjacent to the straight section;
an exterior portion of the ZTA header adjacent to the tapered section of the sealing stem includes a shoulder; and
the tapered section is configured such that an external diameter of the ZTA header increases from the first end to the shoulder.

3. The adapter of embodiment 2, wherein a taper angle of the tapered section of the ZTA header is from 10° to 45°.

4. The adapter of embodiment 2 or 3, wherein a maximum outer diameter of the tapered section of the ZTA header is at least 20% larger than an outer diameter of the straight section the ZTA header.

5. The adapter of any one of embodiments 2-4, wherein the bore of the metal header includes:
a straight section starting at a first end of the metal header;
a sealing alignment cavity adjacent to the straight section;
an internal shoulder adjacent to the sealing alignment cavity; and
a mouth adjacent the internal shoulder starting at a second end of the metal header.

6. The adapter of embodiment 5, wherein:
the mouth of the bore of the metal header includes:
   a straight section adjacent to the internal shoulder; and
   a tapered section including a narrow end and a wide end starting at the second end of the metal header,
   the wide end of the tapered section of the mouth of the bore is at the second end of the metal header; and
the narrow end of the tapered section of the mouth of the bore is adjacent to the straight section.

7. The adapter of embodiment 6, wherein a ratio of a radial thickness of the ZTA header to a radial thickness of the metal header increases moving towards the mouth of the metal header.

8. The adapter of any one of embodiments 5-7, wherein a diameter of the sealing alignment cavity of the metal header is 0.1 mm to 5 mm wider than a diameter of the straight section of the ZTA header.

9. The adapter of any one of embodiments 1-8, wherein the metal header includes a member selected from the group consisting of ferritic steel and Inconel.

10. The adapter of any one of embodiments 1-9, wherein the header seal includes a glass-ceramic system selected from the group consisting of CaO·MgO Al₂O₃·SiO₂, CaO·Al₂O₃·SiO₂, BaO·CaO·Al₂O₃·SiO₂, CaO·ZnO·SiO₂, BaO·Al₂O₃·SiO₂·B₂O₃, BaO·Y₂O₃·SiO₂·B₂O₃, and CaO·La₂O₃·SiO₂·B₂O₃.

11. The adapter of any one of embodiments 1-10, wherein the header seal has a CTE of 8.0×10⁻⁶ K⁻¹ to 10×10⁻⁶ K⁻¹.

12. The adapter of any one of embodiments 1-11, wherein a CTE of the header seal is no more than 2×10⁻⁶ K⁻¹ lower than and no more than 1×10⁻⁶ K⁻¹ higher than a CTE of the ZTA header over a temperature range of 25-800° C.

13. The adapter of any one of embodiments 1-12, wherein the ZTA header has a zirconia content of at least 20 wt. %.

14. The adapter of any one of embodiments 1-13, wherein the ZTA header has a coefficient of thermal expansion (CTE) of 8.5×10⁻⁶ K⁻¹ to 9.3×10⁻⁶ K⁻¹ over the temperature range 25-1000° C.

15. The adapter of any one of embodiments 1-14, further including a multi-socket ZTA manifold base attached to the ZTA header opposite the metal header.

16. The adapter of any one of embodiments 1-14, further including:
a flow separator plate attached to the ZTA header opposite the metal header; and
a base plate attached to the flow separator plate opposite the ZTA header,
wherein:
   the flow separator plate includes a plurality of holes;
   a face of the base plate adjacent to the flow separator plate includes a plurality of holes and a plurality of diagonal channels;
   the holes of the base plate are in fluid communication with a first portion of the holes of the flow separator plate; and
   the channels of the base plate are in fluid communication with a second portion of the holes of the flow separator plate different from the first portion.

17. A system including:
a metal component;
a ceramic component; and
the adapter according to any one of embodiments 1-16;
wherein the adapter joins the metal component and the ceramic component.

18. A system including:
a hydrogen separation membrane reactor including a ceramic-supported membrane including a porous ceramic support and a membrane selected from the group consisting of palladium and a palladium alloy;
a metal reactor component; and
the adapter of any one of embodiments 1-16,
wherein:
   the porous ceramic support is sealed to the ZTA header of the adapter; and
   the metal reactor component is sealed to the metal header of the adapter.

19. A method of forming an adapter, including:
inserting a header seal preform and a portion of a ZTA header into a bore of a metal header; and
heating the metal header, header seal preform, and ZTA header to form the adapter.

20. The method of embodiment 19, wherein the heating causes the header seal preform to flow and contact a surface of the ZTA header and a surface of the metal header and at least partially crystallize.

What is claimed:

1. An adapter, comprising:
a metal header comprising a bore;
a header seal comprising a bore; and
a zirconia toughened alumina (ZTA) header comprising a bore and a sealing stem,
wherein:
the header seal is disposed in the bore of the metal header;
the sealing stem of the ZTA header is disposed in the bore of the metal header; and
the header seal seals the metal header to the ZTA header.

2. The adapter of claim 1, wherein:
the sealing stem of the ZTA header comprises:
a straight section starting at a first end of the ZTA header; and
a tapered section adjacent to the straight section;
an exterior portion of the ZTA header adjacent to the tapered section of the sealing stem comprises a shoulder; and
the tapered section is configured such that an external diameter of the ZTA header increases from the first end to the shoulder.

3. The adapter of claim 2, wherein a taper angle of the tapered section of the ZTA header is from 10° to 45°.

4. The adapter of claim 2, wherein a maximum outer diameter of the tapered section of the ZTA header is at least 20% larger than an outer diameter of the straight section the ZTA header.

5. The adapter of claim 2, wherein the bore of the metal header comprises:
a straight section starting at a first end of the metal header;
a sealing alignment cavity adjacent to the straight section;
an internal shoulder adjacent to the sealing alignment cavity; and
a mouth adjacent the internal shoulder starting at a second end of the metal header.

6. The adapter of claim 5, wherein:
the mouth of the bore of the metal header comprises:
a straight section adjacent to the internal shoulder; and
a tapered section comprising a narrow end and a wide end starting at the second end of the metal header,
the wide end of the tapered section of the mouth of the bore is at the second end of the metal header; and
the narrow end of the tapered section of the mouth of the bore is adjacent to the straight section.

7. The adapter of claim 6, wherein a ratio of a radial thickness of the ZTA header to a radial thickness of the metal header increases moving towards the mouth of the metal header.

8. The adapter of claim 5, wherein a diameter of the sealing alignment cavity of the metal header is 0.1 mm to 5 mm wider than a diameter of the straight section of the ZTA header.

9. The adapter of claim 1, wherein the metal header comprises a member selected from the group consisting of ferritic steel and Inconel.

10. The adapter of claim 1, wherein the header seal comprises a glass-ceramic system selected from the group consisting of CaO·MgO·Al₂O₃·SiO₂, CaO·Al₂O₃·SiO₂, BaO·CaO·Al₂O₃·SiO₂, CaO·ZnO·SiO₂, BaO·Al₂O₃·SiO₂·B₂O₃, BaO·Y₂O₃·SiO₂·B₂O₃, and CaO·La₂O₃·SiO₂·B₂O₃.

11. The adapter of claim 1, wherein the header seal has a CTE of 8.0×10⁻⁶ K⁻¹ to 10×10⁻⁶ K⁻¹.

12. The adapter of claim 1, wherein a CTE of the header seal is no more than 2×10⁻⁶ K⁻¹ lower than and no more than 1×10⁻⁶ K⁻¹ higher than a CTE of the ZTA header over a temperature range of 25-800° C.

13. The adapter of claim 1, wherein the ZTA header has a zirconia content of at least 20 wt. %.

14. The adapter of claim 1, wherein the ZTA header has a coefficient of thermal expansion (CTE) of 8.5×10⁻⁶ K⁻¹ to 9.3×10⁻⁶ K⁻¹ over the temperature range 25-1000° C.

15. The adapter of claim 1, further comprising a multi-socket ZTA manifold base attached to the ZTA header opposite the metal header.

16. The adapter of claim 1, further comprising:
a flow separator plate attached to the ZTA header opposite the metal header; and
a base plate attached to the flow separator plate opposite the ZTA header,
wherein:
the flow separator plate comprises a plurality of holes;
a face of the base plate adjacent to the flow separator plate comprises a plurality of holes and a plurality of diagonal channels;
the holes of the base plate are in fluid communication with a first portion of the holes of the flow separator plate; and
the channels of the base plate are in fluid communication with a second portion of the holes of the flow separator plate different from the first portion.

17. A system comprising:
a metal component;
a ceramic component; and
the adapter according to claim 1;
wherein the adapter joins the metal component and the ceramic component.

18. A system comprising:
a hydrogen separation membrane reactor comprising a ceramic-supported membrane comprising a porous ceramic support and a membrane selected from the group consisting of palladium and a palladium alloy;
a metal reactor component; and
the adapter of claim 1,
wherein:
the porous ceramic support is sealed to the ZTA header of the adapter; and
the metal reactor component is sealed to the metal header of the adapter.

19. A method of forming an adapter, comprising:
inserting a header seal preform and a portion of a ZTA header into a bore of a metal header; and
heating the metal header, header seal preform, and ZTA header to form the adapter.

20. The method of claim 19, wherein the heating causes the header seal preform to flow and contact a surface of the ZTA header and a surface of the metal header and at least partially crystallize.
